(19) United States
(12) Patent Application Publication
(10) Pub. No.: US 2008/0133714 A1
(43) Pub. Date: Jun. 5, 2008

(54) EAGLEEYEOS ZONE: METHOD OF CONTROL OF SEPARATION TECHNOLOGY OF FILE SHARING FOR NETWORK COMPUTERS

(75) Inventors: Tamas GAUTIER, Budapest (HU); Laszlo Kaiser, Nagytarcsa (HU); Csaba Csabai, Paty (HU)

Correspondence Address: SUGHRUE MION, PLLC, 2100 PENNSYLVANIA AVENUE, N.W., SUITE 800, WASHINGTON, DC, 20037, US

(73) Assignee: SAVEAS SERVICE PROVIDER AND CONSULTING PLC., Budapest (HU)

(21) Appl. No.: 11/753,427

(22) Filed: May 24, 2007

Related U.S. Application Data
(60) Provisional application No. 60/808,130, filed on May 25, 2006.

(51) Int. Cl. G06F 15/16

(52) U.S. Cl. 709/219

(57) ABSTRACT

A method for controlling access to network file shares independently from access controls of file shares is provided. The method includes examining a file operation at a client to determine a target destination of the file operation; determining whether the target destination of the file operation is a remote destination to the client; determining whether the target destination of the file operation is in a same realm as the client; and if the file operation is a remote destination and is in the same realm as the client, sending an authorization request to a server. Another method includes examining a file access request of a file operation; controlling access to a file indicated in the file access request based on information in the file access request; and logging accessed and denied file operations.

### BACKGROUND OF THE INVENTION

1. Field of the Invention

Methods and apparatuses consistent with the present invention relate to file sharing on opened or closed networks, and more particularly, to protecting existing networks from illegally connected file sharing capable devices.

2. Description of the Related Art

Related art file sharing protection systems provide protection by simply denying unauthorized file access to users. However, related art systems suffer from a number of problems. Related art systems are dependent on the operating and file systems involved, and thus are impossible to implement in the case where no file level access right handling is provided. Moreover, other forms of file sharing protection such as encryption of data have been proposed to prevent unauthorized file access, but such encryption systems necessarily must modify the data.

Another problem with the related art file sharing protection systems is that even though unauthorized file access is denied, the files are still visible from an illegally connected computer. This allows users operating from an illegally connected computer to target certain files and, for example, to attempt to break any protection scheme which may be in use.

### SUMMARY OF THE INVENTION

Exemplary embodiments of the present invention address the above disadvantages and other disadvantages not described above. Also, the present invention is not required to overcome the disadvantages described above, and an exemplary embodiment of the present invention may not overcome any of the problems described above.

According to an aspect of the present invention, there is provided a method for controlling access to network file shares independently from access controls of file shares, the method including examining a file operation at a client to determine a target destination of the file operation; determining whether the target destination of the file operation is a remote destination to the client; determining whether the target destination of the file operation is in a same realm as the client; and if the file operation is a remote destination and is in the same realm as the client, sending an authorization request to a server.

According to another aspect of the present invention, there is provided a method for controlling access to network file shares independently from access controls of file shares, the method including examining a file access request of a file operation; controlling access to a file indicated in the file access request based on information in the file access request; and logging accessed and denied file operations.

### BRIEF DESCRIPTION OF THE DRAWINGS

Exemplary embodiments of the present invention (hereinafter referred to as: Zone or zone or the software driver) are illustrated by way of example, and not by way of limitation, in the figures of the accompanying drawings:

FIG. 1 illustrates an operation of a software driver in a Local Area Network according to an exemplary embodiment of the present invention;

FIG. 2 illustrates client side authentication within a given file operation according to an exemplary embodiment of the present invention;

FIG. 3A illustrates a server side file operation according to an exemplary embodiment of the present invention;

FIG. 3B illustrates server zone authentication of FIG. 3A according to an exemplary embodiment of the present invention; and

FIG. 4 illustrates a server side LUID cache cleanup method according to an exemplary embodiment of the present invention.

### DETAILED DESCRIPTION OF EXEMPLARY EMBODIMENTS OF THE PRESENT INVENTION

Exemplary embodiments of the present invention are now presented to provide a thorough understanding of the present invention. It will be apparent, however, to one skilled in the art that the present invention may be practiced without these specific details.

According to an exemplary embodiment of the present invention, a software driver is provided for protecting workstations from unauthorized file sharing over a network. The network may be divided into separate zone domains, also referred to as “realms”. Workstations within the same realm may see each other's file shares. Within a zone domain, an identifier, also referred to as a “zone identifier”, is assigned to each workstation by a zone administrator. A network share of a workstation protected by a zone domain may only be accessed from a workstation which is running a software driver according to an exemplary embodiment of the present invention and which holds at least one matching zone identifier. A named data-channel carries the client-server communication, and is also referred to as a “zone authenticating PIPE”.

The software driver according to an exemplary embodiment of the present invention serves as a filter module at the system core level and analyzes all file activities and decides whether the remote file activities are realized by workstations on the network that are members of a zone domain, i.e., realm. There can be more than one realm defined within the same network, and trespassing may be defined independently for each realm.

The software driver allows systems to determine which workstation initiated a given remote file accessing operation at the system core (kernel) level. The software driver examines all file activities on the system core level. If a file activity is found which is intended to initiate activity on a remote file server's shared file, then, the software sends an identification request to the file server on a communication channel that is independent from the file. The identification request contains a realm identifier or identifiers. Protection against unauthorized modification is thus ensured by the multi-level protection of the communication channels, which are independent from each other.

The communication on the communication channel denotes file activities that happen between two computers. The side initiating the file activity is denoted as the client side, while the target of the file activity is the server. Local file activity is a special abstraction, wherein the client side and server are the same.

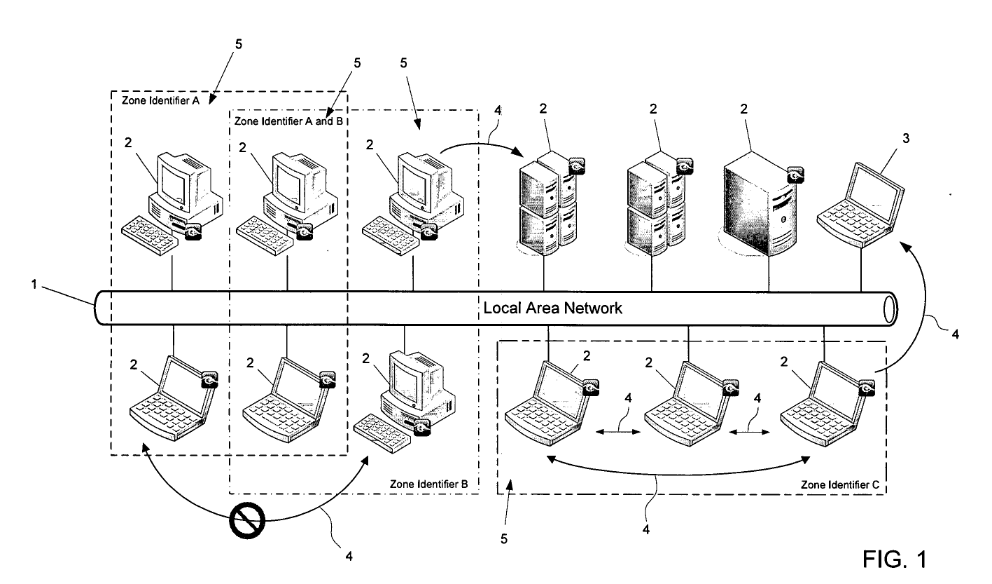

The software driver may also extend the protections of other independent protection technologies, for example quarantine technologies. Quarantine technologies guarantee that the contents of a given network or local folder/share cannot be moved out of the boundaries of a given the quarantined folder/share. The software driver may provide quarantine function related harmonization. Turning now to FIG. 1, shown are computers/workstations in a network 1 from the point of view of the software driver according to an exemplary embodiment of the present invention. Workstations on the network 1 may be split in two groups, protected groups 2 which have the software driver according to an exemplary embodiment of the present invention installed, and unprotected groups 3 which do not have the software driver installed. One or more groups of the workstations with the software driver installed may also sorted into one or more realms 5. As noted earlier, a realm denotes a separated zone domain. Workstations within the same realm can see each other's file shares. A direction of network connections (i.e., file shares) between computers are indicated in FIG. 1 by arrows 4.

On an unprotected workstation, all files can be accessed from a remote direction without any restriction.

On a protected workstation whereon there is the software driver according to an exemplary embodiment of the present invention installed, but the workstation is not in a matching realm (i.e., there is no matching zone identifier), all files can be accessed from a remote direction without any restriction.

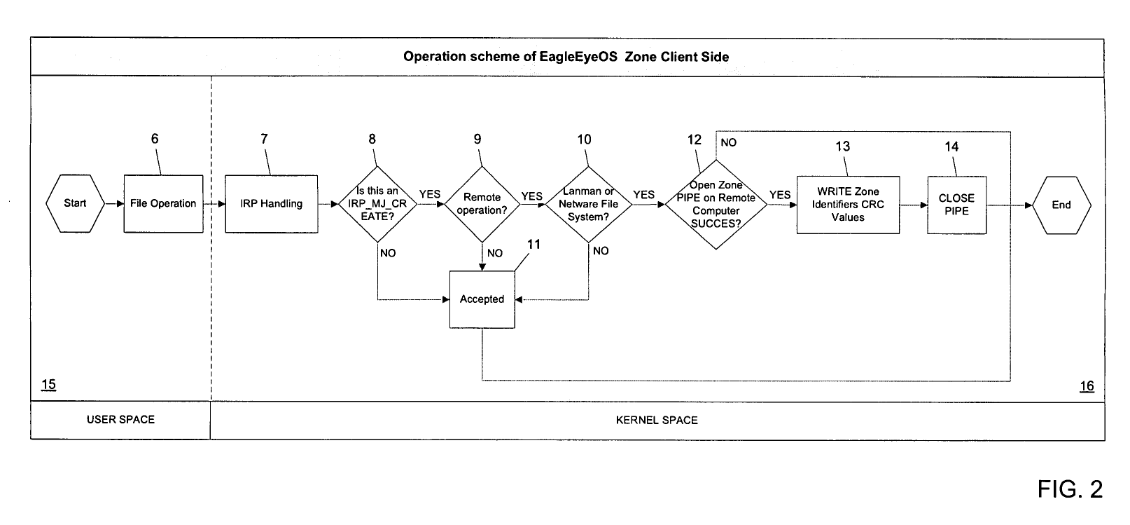

On a protected workstation whereon there is the software driver according to an exemplary embodiment of the present invention installed and the workstation is in one or more realms, files can be accessed from a remote direction only from those protected workstations which have at least one realm in common with the protected workstation. Turning now to FIG. 2, the client side operation, i.e., operation from a workstation that initiated a file access operation is shown. FIG. 2 shows a user space 15 and a kernel space 16. The user space 15 denotes activities that are performed on a user level. For example, in Microsoft Windows operating systems the user level is also called “ring3”. The kernel space 16 denotes activities done on system core level. For example, in the Microsoft Windows operating system, the kernel space 16 is also called “ring0”.

Every file operation 6 initiated by an application goes through an event handler (i.e., IRP handling 7). It is checked whether the file operation 6 is an opening operation, i.e., an IRP_MJ_CREATE at operation 8. If the file operation 6 is an opening operation, then it is determined whether the file operation 6 wants to access a file or files which are on remote fileservers at operation 9. If the file operation 6 does not want to access files on a remote fileserver, then the file operation 6 is accepted at operation 11. At operation 10, it is then determined which file system is the owner of the given file object. For example, in the case of a remote operation in a Microsoft Windows 2000/XP operating system, the owner may be a LanManRedirector or a NovellRedirector. As another example, in Unix/Linux/BSD operating systems, the type of the filesystem can be interrogated from the inode of the file operation. If the type of the file system is nfsd or smbfs, then the file operation 6 is considered to be a remote file operation also. Once the determination is made that the file operation is to go to a remote workstation, then a request for authentication is sent to the server side, if the two workstations are in a same realm. Before letting the given file operation pass through, a new own file operation is to be generated by creating new IRP. If the file operation 6 is not determined to be an opening file operation, i.e., an IRP_MJ_CREATE in operation 8, then the file operation is accepted and passed through without any intervention at operation 11. The new own file operation is generated with the rights of the original file operation, but the target of the new own file operation is not the target of the original file operation, but a “zone authentication PIPE”. A zone authentication PIPE denotes a named data-channel through the zone identification.

A zone authentication PIPE is only opened for writing. It is then checked at operation 12 whether the zone authentication PIPE was successfully opened on the remote computer. In case where the software driver can open the remote PIPE, then the software driver encodes one or more zone identifiers, and writes the encoded one or more zone identifiers CRC values into the PIPE at operation 13 and closes the PIPE at operation 14.

Whilst it is enough to accomplish an access check on the server side, besides of the identification, there is no other denying control necessary to apply on client side.

In the case where a zone authentication PIPE cannot be opened at operation 12, it is determined that there is no software driver according to an exemplary embodiment of the present invention installed on the remote computer.

It is advantageous to hold a proper cache for storing the status of network servers in order to avoid repeating the above process for every remote access.

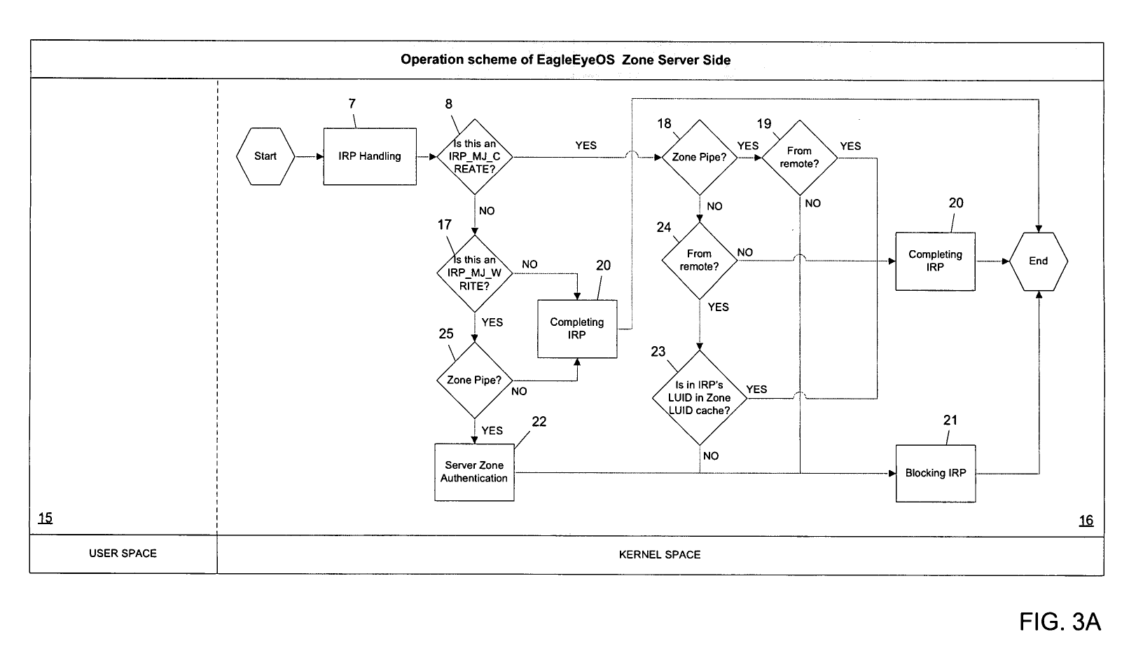

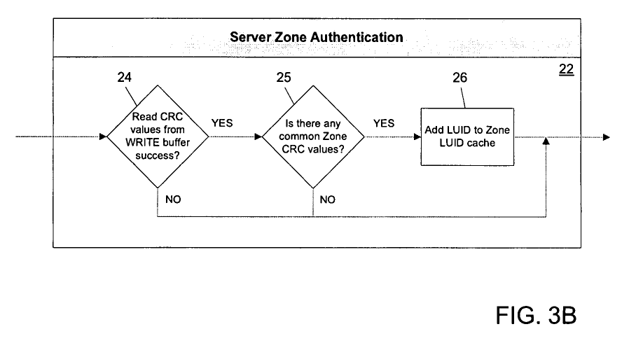

More particularly, an examination is made of each file operation. In the case that a file sharing operation is aimed at a remote file, an authorization request is made to a remote authorizing object. An examination is made of incoming remote file access request, and based on the incoming authorization request, a decision is made about access for file shares, the handling of unique zone identifiers of workstations and the management of access frames (i.e., realms) between them. Accepted and denied operations are logged, and the logs are completed with the zone information. To implement the software driver according to an exemplary embodiment of the present invention, it is useful for a given platform to have a complete path of the target file of the given file operation, and that the given platform support the file access as an operation, i.e., open or IRP_MJ_CREATE., and for the given platform to be able to appoint, whether the file access request has been initiated locally or remotely via either a matching flag, or reporting of a remote accessing attempt by an initiating application). Turning now to FIG. 3, the server side of the file access operation is described. The software driver on the client side checks all basic file operations as indicated above handling. If it is determined that the file opening attempt is aimed to the zone PIPE in operation 18, then it is checked if the opening operation is from a remote workstation in operation 19. If the opening operation is not from a remote workstation, then the initiated requests are blocked (i.e., blocking IRP) in operation 21. If the request is remotely initiated in operation 19, then the request is passed through (i.e., completing IRP) at operation 20.

If the opening attempt is not aimed to the zone PIPE, then it is determined whether the file operation is initiated by a remote unit at operation 24. In case of local requests, the operation can be passed through (operation 20). If the request is remote-initiated, then it is checked to determine if an LUID of the actual operation can be found in the cache of the server side at operation 23. If it is determined that the LUID can be found, then the operation can be passed through (operation 20). If it is determined that the LUID is not found, then the client side unit does not possess the software driver according to an exemplary embodiment of the present invention, or is not in a same realm (i.e., does not have any common realm identifier). Thus, the operation is not passed through and is denied (operation 21).

When the authentication is in progress, it is determined whether the operation is writing, i.e., IRP_MJ_WRITE, at operation 17. If it is not determined that the operation is writing, the operation may be passed through (operation 20). If it is determined that the operation is writing, it is then checked whether the operation is to be written to a zone PIPE at operation 25. If it is determined that the operation is not to be written a zone PIPE, then the operation may be passed through (operation 20). Otherwise, a server side zone identification is performed (operation 22).

Turning now to FIG. 3B, server side zone identification is described. During the server side zone identification, the software driver on the server side attempts to read CRC values from the WRITE buffer of the examined writing operation. If the CRC values are able to be read (operation 24), then it is determined whether there are any common zone CRC values. If there is at least one common identifier with the server side protection, then the two workstations are in the same realm and file access is approved. In such case the LUID of the file operation that initiated the writing process is written in the LUID cache of the server (operation 26) for further proceeding. If the CRC values are not successfully read at operation 24 or if there are no common zone CRC values, then the LUID is not added to the LUID cache.

The software driver which runs on the server side decides if a given file operation is allowed or blocked. The task of the client is only to identify a file operation. By using this methodology, higher performance can be reached, because there is no need to process the decision logic on both the server and client side for each file operation.

In server mode, for server side examinations, two BOOLEAN variables are used. For client side examinations, one BOOLEAN variable is used. The BOOLEAN variables are as follows:

TargetRemote: The actual file operation is aimed to a remote computer (has a meaning in client mode only)

RequestRemote: The actual file operation had been started from a remote computer (has a meaning in server mode only)

RequestorHasZONE: The actual file operation had been started from a remote computer that is protected by a software driver according to an exemplary embodiment of the present invention, and the client and the server computer/workstation are in the same realm (has a meaning in server mode only)

Based on these three values, it can be decided if the certain file operation is allowed or block

### Identifying Remote File Operations

The file operations which are aimed to a remote computer are detected from both the client side and from the server side. The processes are different on both sides.

### Detecting Remote File Operations on the Client Side:

All basic file operations can be inquired and analyzed. To accomplish this analysis, the file name may be analyzed by identifying the file operations directed to a remote direction. For example, if a filename starts with the “\\” pattern, then the file operation is determined to be directed towards a remote direction. However, this does not cover the file operations towards connected network drives.

Because of this, a solution, which is built on the kernel level file system filter technology, is used. For example, the kernel level file system filter technology of Microsoft Windows may be used. Every file operation (i.e., basic IRP) contains one file object (FILE_OBJECT) and one device object (DEVICE OBJECT). From the file object the relative file name can be identified within the device object (the FileName member of the FILE_OBJECT structure contains the relative filename). For example, this can be the following format: “\tempdirectory\samplefile.txt”. It can be seen from the device object, where the file operation is physically (i.e., on a local or on a network resource).

The essence of the filter drivers of the file system is that for every device object, during its loading time, a reference is created, from which all the file operations targeting the certain device object can be analyzed.

Based on the way the device object is loading/connecting, it can be decided if a file operation is directed to a local or network resource. In case the loading is happened as file system loading, then the file operation is directed to a network device (or file system device—on which no direct file operations happen). When a device connection (IRP_MJ_FILE_SYSTEM_CONTROL operation with IRP_MN_MOUNT_VOLUME operation code) initiated the loading, then the file operation is directed to a local resource.

An alternative method to determine whether a file operation is directed remotely is based on the name of the device objects. For example, in Microsoft Windows operating systems, the network resources can be “\Device\LanmanRedirector”, “\Device\NwRdr”, “\Device\NetWareRedirector”, or similar network resource.

### Detecting File Operation Initiated from a Remote Location on the Server Side:

It can be determined from a given file operation whether a file operation is a file opening or another file operation (IRP). Such is the case, for example, where in the Flags member of the FILE_OBJECT object of the basic file operation, the FO_REMOTE_ORIGIN flag exists.

In case where in opening a file the origin of the file operation is needed, then the file operation itself may not be used because the FO_REMOTE_ORIGIN flag is not available during the IRP_MJ_CREATE operation.

The file operation initiated on a remote location goes through some application levels, but on the server there may be no special application the file operation belongs to. The file operation is done by the system process (System). This can be clearly identified on the kernel level, because the identification of the application (i.e., a PID) matches with the identifier which loaded the kernel level component.

By itself it is not enough to decide if the file operation originated on remote location or not, because the system performs other file operations, too. In order to determine whether a file operation is initiated by a remote location, a certain IRP_MJ_CREATE is examine to determine whether it contains an entry identifier (LUID). In practice this means that in the IO_STACK_LOCATION structure of the actual operation, the ClientToken value at the Create parameter is examined to see if it is valid, as shown in the following sample code:

```
BOOLEAN
ZONE_IsCreateFromRemote (
  IN PIO_STACK_LOCATION IrpSp )
{
  if ( !IrpSp
    || !(IrpSp->MajorFunction == IRP_MJ_CREATE)
    || !IrpSp->Parameters.Create.SecurityContext
    || !IrpSp->Parameters.Create.SecurityContext->AccessState
    || !IrpSp->Parameters.Create.SecurityContext->AccessState-> \
      SubjectSecurityContext.ClientToken )
  {
    return FALSE;
  }
  return TRUE;
}
```

There are exceptions, however, because there can be a system process, which possesses these parameters, but which is not remotely originated (for example, file operations of the kernel components generated by different encryption software). Therefore another check is used. Between the parameters of IRP_MJ_CREATE, in the DesiredAccess value, it is checked to determine whether the SYNCRONIZE identifier is present, because the SYNCRONIZE identifier is present only if the file operation is locally originated.

### Control of the Realm of a Remote Request

The zone identifier: The zone identifier, assigned to each of the workstations, is set by the a zone administrator. A workstation protected by the software driver can be only accessed (via network share) from a computer, which also runs the software driver according to an exemplary embodiment of the invention, and holds at least one zone identifier, which is assigned to the protected unit, too.

The control of the zone identifiers happens as follows. Both on the client and server sides, there is a list containing zone identifiers applied to certain computers. From these, with the help of two parallel adler32 CRC algorithms, a CRC is generated with an upper 32-bit word created out of the even bytes, and lower 32-bit word created out of the odd bytes. On this way a 64-bit CRC value is created. Thus, on both client and server sides of the communication there is, for example, created a list:

```
DWORD64 ZoneIDCRCValues[ ] = {
  DWORD64 ZoneIDCRC_1;
  DWORD64 ZoneIDCRC_2;
  DWORD64 ZoneIDCRC_3;
  DWORD64 ZoneIDCRC_n;
};
```

Practically the client writes the bulk known by itself into the pipe. The software driver according to an exemplary embodiment of the present invention examines the buffers of the writings going to the pipe on the server side.

In case of IRP realization, it can be found in the data parts Parameters.Write.Length by the Irp->UserBuffer or in the IO_STACK_LOCATION structure (data and the length of the data).

In fast I/O realizations, the handling formula of the WRITE operation will receive these data directly.

Based on the received data, the server side commanding application simply compares the ZoneIDCRCValues bulk from the pipe with its own one. If it finds matching ones, then those are in the same realm, otherwise not.

### Technical Description of the Identification Communication Channel:

The channel of the identification request is a named PIPE (named pipe) object, which can be accessed from other workstations also. The software driver is responsible for the creation, existence, and maintenance of the named PIPE object (furthermore PIPE), and for protecting the named PIPE against overloading.

For example, the software driver creates a PIPE named “EEZonePipe” and uses it for the identified communication. The PIPE needs to be created in write only mode, blocking an outsider person or application from accessing any data, which appears in PIPE. On the server side, the PIPE has to possess such rights that all users known in the operation system have to have writing rights on. For example, in Microsoft Windows operating systems it is guaranteed by objects made by the so called Null Dacl Security Descriptor.

### Creating the Named Pipe

Creating the named PIPE happens similarly to the way all users, who are able to access the computer running as the server, access and are able to write to the server. For example, this is assured by the Null Security Descriptor of Microsoft Windows operating systems. This can be created, as follows:

```
SECURITY_ATTRIBUTES *GetNullDacl( )
{
  SECURITY_ATTRIBUTES *ret = new SECURITY_ATTRIBUTES;
  if ( !ret ) return NULL;
  ZeroMemory ( ret, sizeof(SECURITY_ATTRIBUTES) );
  ret->nLength = sizeof(SECURITY_ATTRIBUTES);
  ret->bInheritHandle = FALSE;
    SECURITY_DESCRIPTOR * SD =
    new SECURITY_DESCRIPTOR;
    BOOL bInitOk = InitializeSecurityDescriptor( SD,
SECURITY_DESCRIPTOR_REVISION );
    if( bInitOk )
    {
        // give the security descriptor a Null Dacl
        // done using the “TRUE, (PACL)NULL” here
        BOOL bSetOk = SetSecurityDescriptorDacl( SD,
```

TRUE,
(PACL)NULL,
FALSE );

```
        if ( bSetOk )
        {
            // Make the security attributes point
            // to the security descriptor
            ret->lpSecurityDescriptor = SD;
            return ret;
        }
    }
  if ( SD ) delete SD;
  if ( ret ) delete ret;
  return NULL;
}
```

Since the application responsible for the existence of the pipes must be able to stop in every case, the pipe copies are created in overlapped mode, to avoid the waiting for the communication (which is not guaranteed) by synchronous processes. The problem of the overlapped handling is that, because the synchronizing objects (events) control the asynchronous process, it is not or very limitedly able to handle more parallel connections.

To be able to revise in the same time more zone identification requests on the server side, without the decreasing of the client side performance, it is recommended that more pipe instances are created. For example, ten parallel pipe instances may be created.

Based on the above detailed, creating a pipe instance happens as follows:

```
SECURITY_ATTRIBUTES * pNullDacl = GetNullDacl( );
hPipeInst = CreateNamedPipe (
  _T(“\\\\.\\PIPE\\EEZonePipe”),
PIPE_ACCESS_INBOUND|FILE_FLAG_OVERLAPPED|
  FILE_FLAG_WRITE_THROUGH,
  PIPE_TYPE_BYTE|PIPE_READMODE_BYTE|PIPE_WAIT,
  INSTANCES,
  BUFSIZE,
  0,
  PIPE_TIMEOUT,
  pNullDacl );
DelNullDacl (pNullDacl );
```

On the client side, the entire absolute path is examined. For example, a path “\\fileserver\fileshare\files\file1.txt” can be appointed the name of the pipe responsible to identify the zone from (in this example is: “\\fileserver\PIPE\EEZonePipe”. After it, the pipe is opened and the CRC values of the zone are written into the PIPE. For example, this can be done in Microsoft Windows' kernel with the following call:

```
wCreateFile ( &hPipe,  // returned pipe handle
        GENERIC_WRITE,
        &objAttr,  // the name of the pipe
        &ioStatus,  // extend error return value
        NULL,
        FILE_ATTRIBUTE_NORMAL,
FILE_SHARE_READ|FILE_SHARE_WRITE|
        FILE_SHARE_DELETE, FILE_OPEN,
FILE_NON_DIRECTORY_FILE|
        FILE_SYNCHRONOUS_IO_NONALERT, NULL,
        0 );
```

In case the opening is successful, then the calculated CRC values from the zone identifiers are written into the PIPE. Practically this means, a DWORD64 bulk is written in:

```
wWriteFile ( hPipe,
        NULL,
        NULL,
        NULL,
        &ioStatus,
        (PVOID)ZoneIDCRCArray,
        NumOfZoneIDs*sizeof(DWORD64),
        NULL,
        NULL );
```

It not necessary to deal with the return value of the writing, because allowance or blocking of the original file operation will be done by the software driver on the server side.

### Special Handling Cases

### Protection Against CACHE Overload:

After a successful CACHE result, an item cannot be deleted from the CACHE because it is not known from that one file open operation how many IRP_MJ_CREATE are generated by other software installed on the client.

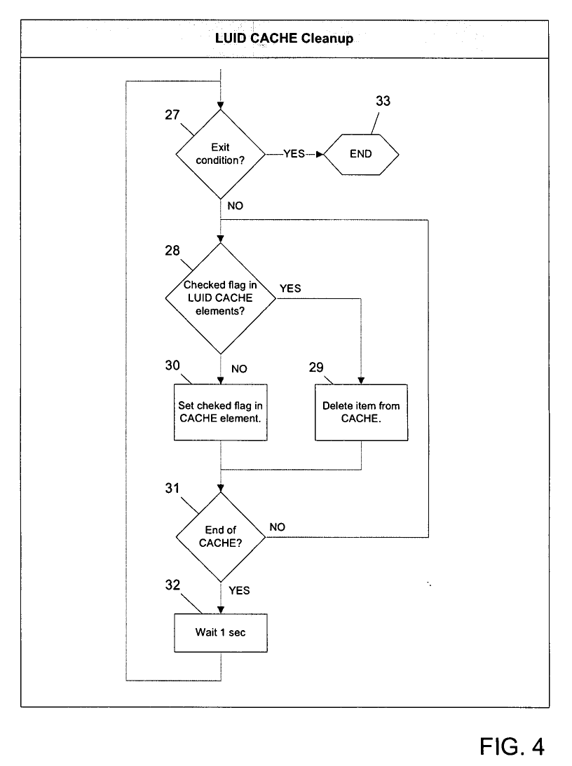

Turning now to FIG. 4, a process of deletion is shown. A cache controlling thread is created, which runs during the entire runtime and which checks with one second timing the cache items. Whereas it finds such items wherein the checked parameter is not set, then sets it, wherein the parameter is set, deletes it from the cache. This is done for all items until the end of the cache.

More particularly, it is first determined at operation 27 whether an exit condition exists. If an exit condition exists, the process is ended (operation 33). If an exit condition does not exist at operation 27, it is determined whether there is a checked flag in LUID CACHE for an element (operation 28). If there is a checked flag for an element, the item is deleted from the CACHE (operation 29). If there is not a checked flag at operation 28, then a checked flag is set in the CACHE element (operation 30). It is then checked whether the end of the CACHE has been reached (operation 31). If the end has not been reached, then the process returns to operation 28. If the end of the CACHE has been reached, the process waits one second (operation 32) and returns to operation 27.

### Technologies that Guarantee the Security and Provide Protection from Unauthorized Modifications of Communication:

During identification process, the realm identifiers are not sent, but rather the identifiers' 64-bit CRC values. To create the CRC values, the software driver calculates two parallel ADLER32 CRC values (on the realm identifiers' even and odd bytes)

All file operations towards the PIPE are blocked. However during the communication there is a need to forward data, but it doesn't happen in reality. The software driver on the server side analyzes the data to be written and decides, but does not allow the real writing process itself. Therefore the data written on the PIPE will be discarded before the real writing action would happen.

The creation of the PIPE can be done in write only mode, to block from any unauthorized person or application to read any related data.

According to exemplary embodiments of the present invention, all data protected by the software driver are hidden from illegally connected network clients.

Since the software driver according to an exemplary embodiment of the present invention runs independently from the operating and file system, it can be used also in cases where these kinds of restrictions are not supported, for example in those file systems that have no file level access right handling.

According to exemplary embodiments of the present invention, independence assures that protected data can not be accessed from illegally connected computers (e.g. not controlled by network management) not even with valid access rights.

The present inventive concept has been described above with reference to exemplary embodiments thereof. It will, however, be evident that to those skilled in the art that various modifications and changes may be made thereto without departing from the spirit and scope of the invention as disclosed in the accompanying claims.

What is claimed is:

1. A method of controlling access to network file shares independently from access controls of file shares, the method comprising:
examining a file operation at a client to determine a target destination of the file operation;
determining whether the target destination of the file operation is a remote destination to the client;
determining whether the target destination of the file operation is in a same realm as the client; and
if the file operation is a remote destination and is in the same realm as the client, sending an authorization request to a server.

2. The method of claim 1, wherein examining a file operation to determine a target destination of the file operation comprises examining a type of file system that is an owner of a file object of the file operation.

3. The method of claim 2, wherein examining a type of the file system comprises examining an inode of the file operation.

4. The method of claim 1, wherein examining a file operation to determine a target destination of the file operation comprises examining a path of a target file which is an object of the file operation.

5. The method of claim 1, further comprising if the target destination is a remote destination, setting a flag to indicate that the target destination is a remote destination.

6. The method of claim 1, further comprising:
creating a new file operation which has a same right as the file operation and which is directed to a zone authentication PIPE;
encoding zone identifiers;
writing the zone identifiers onto the zone authentication PIPE; and
closing the zone authentication PIPE.

7. A method of controlling access to network file shares independently from access controls of file shares, the method comprising:
examining a file access request of a file operation;
controlling access to a file indicated in the file access request based on information in the file access request; and
logging accessed and denied file operations.

8. The method of claim 7, wherein the information in the file access request comprises information on at least one realm of a client.

9. The method of claim 7, wherein the information on the at least one realm comprising at least one zone identifier.

10. The method of claim 7, wherein if the file operation is a write operation, determining access further comprises:
determining whether the file access request is aimed to a zone authentication PIPE;
if it is determined that the file access request is not aimed to the zone authentication PIPE, allowing the file operation;
if it is determined that the file access request is aimed to the zone authentication PIPE, performing server zone authentication and denying the file operation.

11. The method of claim 10, wherein performing server zone authentication comprises:
reading zone CRC values from a WRITE buffer;
determining whether there are any common zone CRC values; and
if there are common zone CRC values, adding a LUID to a zone LUID cache.

12. The method of claim 7, wherein if the file operation is a create operation, determining access further comprises:
making a first determination whether the file access request is aimed to a zone authentication PIPE;
making a second determination whether the file access request is initiated from a local or remote location; and
determining access based on a result of the first determination and second determination.

13. The method of claim 12, wherein it is determined that the file access request is not aimed to the zone authentication PIPE and the file access request is initiated from a remote location, determining whether an LUID of the file request is in a zone LUID cache, and if the LUID is in the zone LUID cache, allowing access.
